(19) United States
(12) Patent Application Publication
(10) Pub. No.: US 2014/0102980 A1
(43) Pub. Date: Apr. 17, 2014

(54) PROCESS AND APPARATUS FOR TREATING PERCHLORATE IN DRINKING WATER SUPPLIES

(71) Applicants: Neil Edwin Moe, Las Cruces, NM (US); Mohamadali Sharbatmaleki, Las Cruces, NM (US)

(72) Inventors: Neil Edwin Moe, Las Cruces, NM (US); Mohamadali Sharbatmaleki, Las Cruces, NM (US)

(73) Assignee: General Electric Company, Schenectady, NY (US)

(21) Appl. No.: 14/123,302

(22) PCT Filed: Jun. 1, 2012
(86) PCT No.: PCT/US2012/040336

§ 371 Date: Dec. 2, 2013

Related U.S. Application Data
(60) Provisional application No. 61/492,620, filed on Jun. 2, 2011.

(51) Int. Cl. C02F 9/00; C02F 1/44; C02F 1/469; C02F 1/42

(52) U.S. Cl. CPC C02F 9/00; C02F 1/42; C02F 1/442; C02F 1/441; C02F 1/4693
USPC 210/638; 210/670; 210/663; 210/661; 210/252; 210/259; 210/251; 210/195.2

(57) ABSTRACT

A process and apparatus treat brackish or non-brackish waters containing an oxidant such as perchlorate. The feed water is converted into a treated water stream and a concentrate stream in an ED, EDR, NF or RO unit. The concentrate passes through an IX resin. The IX resin removes oxidant from the concentrate stream to produce a second treated water stream. The IX resin is periodically regenerated, for example biologically in a fluidised bed reactor in regeneration system. Concentrate that has passed through the IX resin has a reduced concentration of oxidant, preferably a concentration safe for discharge or use. In the case of a brackish feed water, the second treated water stream may be desalted.

### BACKGROUND OF THE INVENTION

1. Field of the Invention

This specification relates to a method and apparatus for treating water, for example municipal drinking water, to a method and apparatus for removing perchlorate or other oxidants from water, and to treatment technologies such as electrodialysis, membrane filtration, ion exchange and biological regeneration of ion exchange materials.

2. Description of the Prior Art

The following description of background of the invention is not an admission that anything described in this section is common knowledge or citable as prior art.

Water to be used for drinking, such as surface water or well water, may be contaminated with one or more oxidants that must be reduced to acceptable concentrations before the water can be used. For example, perchlorate contamination has been detected in many surface water and groundwater supplies throughout the United States. The State of California requires perchlorate concentrations in drinking water to be less than 6 parts per billion. In February 2011, the US Environmental Protection Agency announced that it has decided to regulate perchlorate as a contaminant under the Safe Water Drinking Act. Accordingly, a national primary drinking water regulation will be developed regarding perchlorate concentrations for public drinking water systems.

In some cases, groundwater supplies are also brackish in addition to being contaminated with perchlorate. However, considering the shortage of drinking water in some states such as New Mexico, it may be necessary to use saline and brackish waters that are contaminated with perchlorate to meet drinking water needs. This water must be treated to remove both the perchlorate and the salinity.

Most perchlorate salts are highly soluble and non-volatile. Perchlorate is not effectively removed from water by conventional low cost water treatment techniques such as coagulation, sedimentation or particle filtration. Biological reduction of perchlorate has been demonstrated, but the degredation kinetics are slow, particularly when the water has small perchlorate concentrations. Physiochemical methods such as ion-exchange (IX), electrodialysis (ED), reverse osmosis (RO) and enhanced activated carbon removal are capable of physically separating perchlorate ions from water being treated, but they do not destroy the ion.

In one example, a water treatment system in Magna, Utah treats a groundwater supply containing material concentrations of silica, arsenic and perchlorate. The perchlorate is removed through an electrodialysis reversal (EDR) system. The EDR brine, which contains concentrated perchlorate separated from the groundwater, is combined with a domestic wastewater stream and sent to an anaerobic digestor. After perchlorate is removed in the digestion system, the effluent is discharged to a conventional wastewater treatment system. The process is described in U.S. Pat. No. 7,318,895.

Perchlorate is treated more frequently with ion-exchange resins. In some cases, the resin cannot be effectively regenerated and is instead wasted, for example by incineration, after a one-time use. In other cases the resins may be regenerated, which typically produces a regenerant waste stream containing a high concentration of perchlorate. Since the perchlorate is a contaminant, the waste regenerant stream should not be sent back to the environment. US Patent Application Publication 2003/0222031 A1 proposes a method of treating a regenerant stream containing perchlorate, ferric chloride and hydrochloric acid. The regenerant stream is mixed with a reagent, such as an organic alcohol or ferrous chloride, and maintained under a specified high temperature and high pressure in a reactor to decompose the perchlorate. In another proposed process, ion exchange resins that have been used to remove perchlorate are regenerated by exposing them to a liquid containing micro-organisms that destroy perchlorate. Variations of this process are described in U.S. Pat. Nos. 7,407,581 and 7,465,400.

### BRIEF SUMMARY OF THE INVENTION

This specification describes a process and apparatus that may be used to treat oxidant-contaminated waters. Either brackish or non-brackish waters may be treated. The oxidant may be perchlorate.

In a first stage of a process and apparatus described in this specification, a treated water stream and a concentrate stream are produced by passing feed water through an ED, EDR, RO or nanofiltration (NF) membrane unit. Perchlorate concentration and salinity, in the case of brackish feed water, are reduced in the treated water stream and increased in the concentrate stream. In a second stage, the concentrate passes through an IX resin bed. The IX resin removes perchlorate from the concentrate stream. In a third stage, the IX resin is regenerated. For example, water from a biological reactor containing perchlorate-reducing micro-organisms may be used to biologically regenerate the IX resin. Concentrate that has passed through the IX resin has a reduced concentration of perchlorate, preferably to the point of being safe for discharge or use as a second treated water stream, optionally after further treatment. For example, in the case of a brackish feed water, the second treated water stream may be further concentrated and additional desalinated water recovered before the concentrate is disposed.

### BRIEF DESCRIPTION OF THE DRAWINGS

FIG. 1 is a schematic representation of a water treatment system for removing perchlorate.

FIG. 2 is a schematic representation of a water treatment system as in FIG. 1 having an ED or EDR unit and an IX unit in an ED/EDR concentrate loop.

FIG. 3 is a schematic representation of a water treatment system as in FIG. 1 having an ED or EDR unit and an IX unit in a side stream to an ED/EDR concentrate loop.

FIG. 4 is a schematic representation of a water treatment system similar to the system of FIG. 2 wherein the ED or EDR receives an independent concentrate make up stream.

FIG. 5 is a schematic representation of a water treatment system similar to the system of FIG. 3 wherein the ED or EDR receives an independent concentrate make up stream.

### DETAILED DESCRIPTION OF THE INVENTION

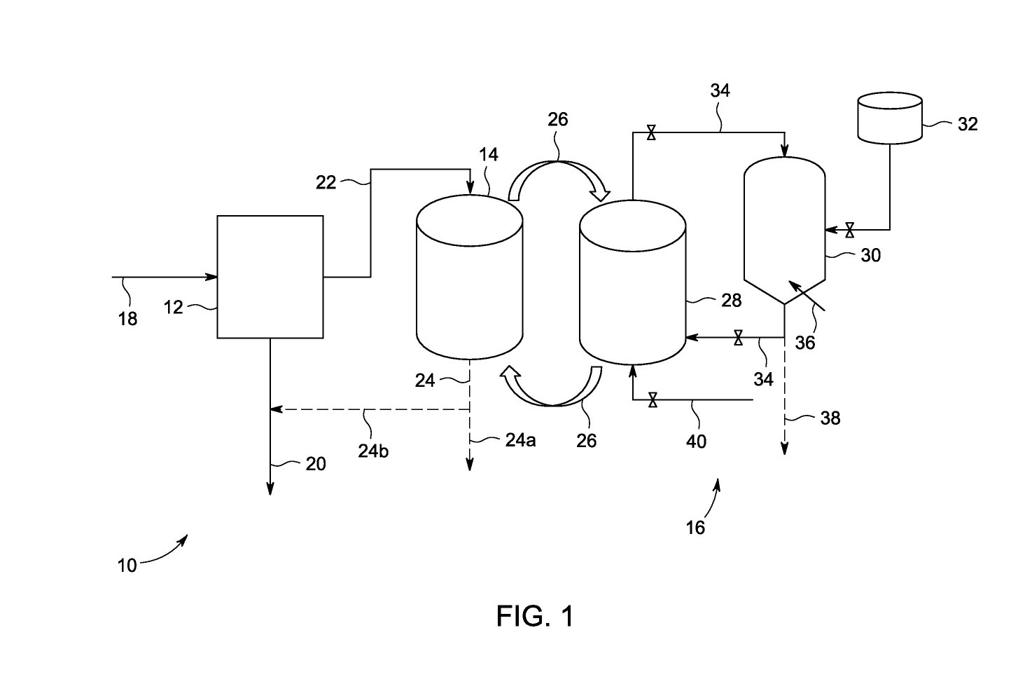

FIG. 1 shows a water treatment system 10 for treating a feed water 18. The feed water 18 may be drawn, for example, from a well or a surface water source and may be brackish or non-brackish. The feed water 18 is contaminated with an oxidant. The oxidant may be, for example, one or more of perchlorate, nitrate, phosphate or sulphate. In the following discussion, at least some perchlorate must be removed from the feed water 18 to produce water that may be used for a municipal potable water supply, although other oxidants may also be present in the feed water 18 and removed by the system 10.

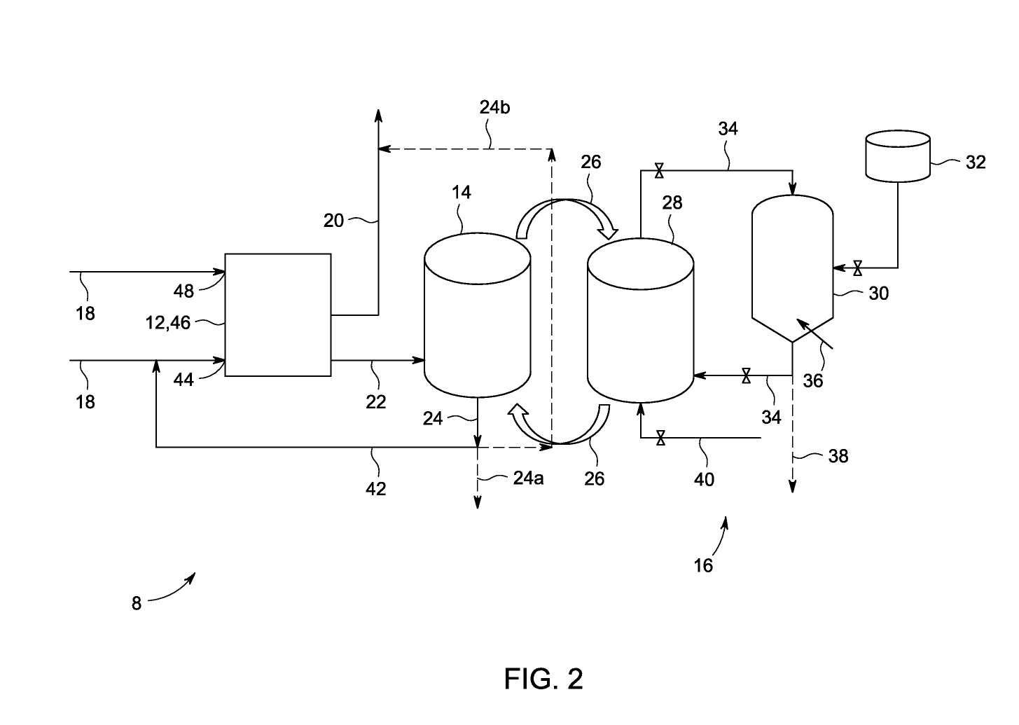

The water treatment system 10 has a separation unit 12, an ion exchange (IX) unit 14 and a regeneration system 16. After any optional pre-treatment steps, a feed water 18 flows into the separation unit 12. The separation unit 12 produces a first treated water stream 20 and a concentrate stream 22. The first treated water stream 20 preferably has a concentration of perchlorate that is safe or below any applicable regulatory limits. The separation unit 12 may be, for example, an electrodyalisis (ED) or electrodialysis reversal (EDR) unit 46, a reverse osmosis (RO) membrane unit or a nanofiltration (NF) membrane unit. In an ED or EDR unit 46, the perchlorate, and salinity in the case of brackish feed water 18, pass from the feed water 18 through a membrane into the concentrate stream 22 leaving the treated water 20. A portion of the concentrate stream 22 is recycled to the ED/EDR unit 46 and mixed with concentrate make up water 52, as will be described further below in relation to FIGS. 2 to 5. In an RO or NF membrane unit, treated water 20 is removed through a membrane leaving the membrane retentate, alternatively called brine or reject, containing most of the perchlorate, and salinity in the case of a brackish feed water 18, as the concentrate stream 22.

Because of the difference in operation mentioned above, ED or EDR units 46 may be preferable to RO or NF membranes, particularly if a perchlorate-selective membrane is used in the ED or EDR unit 46. For example, monovalent and nitrate selective membranes are likely to also be perchlorate selective. In the case of perchlorate contaminated non-brackish water, removal of any ions besides perchlorate may not be necessary and so using a perchlorate-selective membrane may provide the most energy efficient membrane process. A process with perchlorate-selective membranes may be capable of higher recovery since perchlorate salts are highly soluble, unlike some sulfate salts, and the selection of perchlorate ions may minimize the size of the IX unit 14 and regeneration system 16. A third advantage of using perchlorate selective membranes is the possibility to remove more perchlorate in fewer stages when compared to conventional non-selective or divalent selective membranes. In addition to the choice of membrane material, the selection of process conditions (i.e. flow, temperature, current density, and feed chemistry) may improve perchlorate selectivity. Further, additional steps to remove competing anions such as nitrate and sulphate may enhance selectivity in the separation unit 12, improve perchlorate capture in the ion exchange unit 14, and enhance biological regeneration of the IX resins.

The concentrate stream 22 passes through the IX unit 14. The IX unit 14 contains a bed of anion exchange resin beads, for example gel type resin beads. The IX unit 14 preferably contains perchlorate-selective resin to encourage selective removal of perchlorate ions from the concentrate stream 22, and to inhibit the exchange of counter ions with various competitive anions (e.g. carbonate, chloride, sulfate, bicarbonate, phosphate, nitrate, fluoride, etc.) that might be present in the concentrate stream 22. In feed waters 18 with low concentrations of competitive anions, a non-selective resin or less selective resin might be used. Sulfate is the main competitive ion in conventional (non-selective) anionic exchange resins. Sulfate ions may exhaust most of the capacity of a non-perchlorate selective resin. However, the feed water 18 may be low in sulfates, the separation unit 12 may concentrate perchlorate more than sulphate in the concentrate 22, or an additional sulphate removal step may be provided, thus allowing a non-selective resin or less selective resin to be used.

Perchlorate ions from the concentrate stream 22 are retained by the resin in the IX unit 14. A second treated water stream 24 leaves the IX unit 14 with a reduced concentration of perchlorate, preferably a concentration of perchlorate that is safe or below any applicable regulatory limits, either for use as treated water or for discharge. If the feed water 18 was brackish, the second treated water stream 24 will be a brackish treated stream 24a with a high total dissolved solids (TDS) concentration, the TDS having been removed from the first treated water stream 20. The brackish treated stream 24a may be fed to a secondary desalination process such as an evaporator, membrane unit or distillation unit, not shown, to recover water to be mixed with the first treated water stream 20 or used for some other purpose. Alternatively, the brackish treated stream 24a may be discharged in the manner of other non-toxic desalting brines.

If the feed water 18 was non-brackish, the second treated water stream 24 will be a second product water stream 24b. The second product water stream 24b can be combined with the first treated water stream 20. Alternatively, the second product water stream 24b may be used for another purpose or discharged.

The first treated water stream 20 may be used, for example, for municipal potable water supply. Optionally, further polishing or disinfection steps may be provided before the water enters the municipal supply system. The second product water stream 24 may also be used, for example, for municipal potable water supply optionally after further treatment steps. In addition to desalting, such further treatment steps may include a disinfection step to remove or destroy any microbes collected from the ion exchange unit 14 or present in the feed water 18. For either treated water stream 20, 24, disinfection may be by way of one or more of chlorination, ultraviolet (UV) treatment or membrane filtration. Alternatively, the two product water streams 20, 24 may be used for different purposes. For example, the first product water stream 20 may be used for potable water while the second product water stream 24 is used for irrigation, toilet flush water, industrial water, or some other non-potable use.

When the resin in the IX unit 14 is at or near its limit of total perchlorate removal, the resins are regenerated. In FIG. 1, the arrows 26 indicate a physical transfer of the resin to a fluidized bed reactor 28 of the regeneration system 16. Optionally, however, the regeneration may be performed in situ in the IX unit 14. In that case, an IX unit 14 is taken off-line in relation to the parts of the system that treat feed water 18 and notionally, or temporarily, considered part of the regeneration system 16.

If the resin is highly perchlorate-selective, the resin is difficult to regenerate using a conventional brine treatment and so the regeneration system 16 may act directly on the resin rather than on a liquid regenerant. The resins are bio-regenerated by placing them in communication with a liquid recirculation loop 32 that is part of a biological process, for example an anaerobic biological process. The IX resins, in the original ion exchange unit 14 or in a separate fluidized bed reactor 28, are connected to a bioreactor 30, for example a fermentor. The bioreactor 30 contains a perchlorate-reducing microorganism culture. The microbial culture may be obtained, for example, by cultivating a population of microbes taken from perchlorate contaminated surface water. A seeding or make up stream of microbes 36 may be added during start up or operation of the bioreactor 30. Liquid carrying micororganisms 34 from the culture is pumped from the bioreactor 30 to the fluidized bed reactor 28, and flows through the resin bed, for example upwards, and back to the bioreactor 30. The microorganisms convert perchlorate in or on the resin into chloride. An electron donor source 32 is preferably added to the bioreactor 30 to enhance the growth of the microorganisms. A bioreactor waste stream 38 from the bioreactor 30 removes excess or dead microorganisms. After the resin has been regenerated, a rinse water 40, optionally including a disinfectant, may be passed through the fluidized bed reactor 28 or IX unit 14 to kill microbes on the resin, or remove microbes from the resin, before more second treated water 24 is produced. Details of the bioregeneration of IX resins loaded with perchlorate were reported in, for example, Venkatesan, A. K., Sharbatmaleki, M., & Batista, J. R. (2010), Bioregeneration of perchlorate laden gel-type anion-exchange resin in a fluidized bed reactor, J. Hazard. Mater. 177, 730-737, which is incorporated herein by this reference to it. Other regeneration methods, for example the method described in US Patent Application Publication 2003/0222031 A1, may also be used.

FIG. 2 shows a second water treatment system 8 wherein the separation unit 12 is an ED or EDR unit 46. The ED/EDR unit 46 has a product water inlet 48 and a concentrate water inlet 44. Feed water 18 containing perchlorate is fed to both of the inlets 44, 48. Optionally, though not shown, a portion of the product water 20 may be recycled to the product water inlet 48. Further optionally, as shown, a portion of the second product water stream 24 may be used as a concentrate recycle stream 42 and returned to the concentrate water inlet 44. In other respects, the second water treatment system 8 operates as described in relation to FIG. 1.

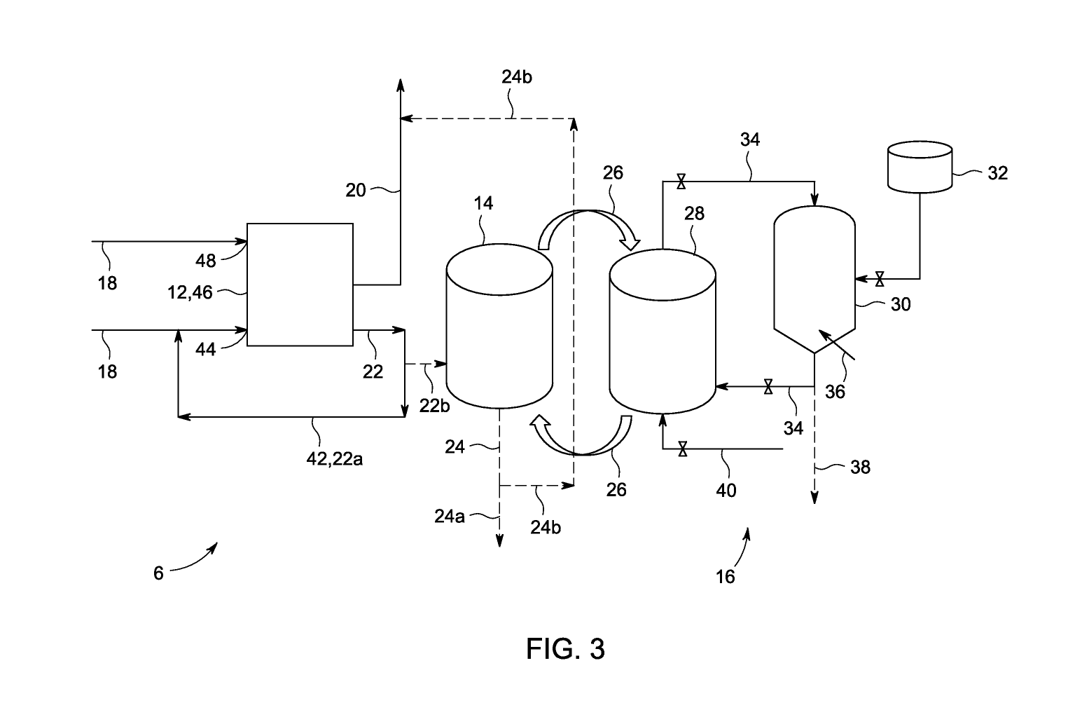

FIG. 3 shows a third water treatment system 6 wherein the separation unit 12 is also an ED or EDR unit 46 having a product water inlet 48 and a concentrate water inlet 44. Feed water 18 containing perchlorate is fed to both of the inlets 44, 48. Optionally, a portion of the product water 20 may be recycled to the product water inlet 48. Further optionally, as shown, a first portion 22a of the concentrate stream 22 may be used as a concentrate recycle stream 42 and returned to the concentrate water inlet 44. A second portion 22b of the concentrate stream 22 flows to the ion exchange unit 14. In other respects, the third water treatment system 6 operates as described in relation to FIG. 1.

An example of a third water system 6 was modeled for use treating a 135 US gallons per minute (gpm) (511 liters per minute (l/m)) flow of brackish feed water 18 having 20 parts per billion (ppb) of perchlorate and 1300 parts per million (ppm) of total dissolved solids (TDS). The separation unit 12 in the model consists of two stages in series of GE 2020 EDR modules, available from GE Water and Process Technologies, having MK-IV-2 stacks with 600 cell pairs per stage. The membranes in the EDR stacks are assumed to not be perchlorate selective, and to remove perchlorate to the same extent as TDS. For simplicity, small electrode streams and an off-specification product water stream that would be produced by an EDR unit 46 will not be described in the description above. These small streams would typically be recycled back to the feed stream 18.

The feed water 18 is split such that 122 gpm (462 l/m) flows to the product water inlet 48. This produces a first product water 20 at 120 gpm (454 l/m), 2 gpm (8 l/m) being lost to the concentrate side of the EDR unit 46 due to electro-osmosis and hydraulic leaks. However, perchlorate is reduced to 5 ppb perchlorate and TDS is reduced to 325 ppm in the first product water 20. The first product water 20 thus meets anticipated drinking water standards.

The remaining 13 gpm (49 l/m) of feed water 18 is sent to the concentrate water inlet 44. A concentrate stream 22 of 105 gpm (397 l/m) is produced having 140 ppb of perchlorate and 9100 ppm TDS. This concentrate stream is divided into a concentrate recycle stream 42 of 90 gpm (341 l/m) and a second portion 22b (alternatively call an EDR blowdown) of 15 gpm (57 l/m).

The EDR blowdown 22b is sent to an ion exchange unit 14 having ResinTech SIR-110-HP resin, which is perchlorate selective. The ion exchange unit 14 has a hydraulic retention time of 5 US gallons per minute per cubic foot of resin (0.7 l/m per liter of resin), and a three cubic foot (85 liter) total resin volume. The resin in the ion exchange unit 14 is regenerated after 60 days of use. Over this time the resin has removed 34.4 equivalents of perchlorate, which is 15% of the total ion exchange capacity of the resin. The resin is removed to a fluidized bed reactor 28 for regeneration. Regeneration requires about 10 days under anaerobic or anoxic conditions. During this time, the ion exchange reactor 14 is assumed to be off line or used with replacement resin. A brackish treated stream 24a of 15 gpm is produced having 9100 ppm of TDS but essentially no perchlorate. The brackish treated stream 24a is safe for discharge in the same manner as other brines, or could be further treated to remove salinity and mixed with the first treated water 20 or used for other purposes.

The fluidized bed reactor 28 has a volume of 6 cubic feet (170 liters), allowing for 50% volume expansion of three cubic feet of resin and a 1.5 cubic foot (42 liters) headspace. The bioreactor 30 has a volume of 12 cubic feet (340 liters). The bioreactor 30 has a total suspended solids (TSS) concentration of 2000 ppm and contains Dechlorosoma sp. GR-1 bacteria. Acetate is provided as an electron donor 32 at an acetate:perchlorate molar ratio of between 1.2:1 and 3.0:1. Trace amounts of micro-nutrients may also be provided with the electron donor 32 to improve bacterial growth. During the 10 day regeneration period, the electron acceptor is perchlorate from the ion exchange resin. During the time between regenerations of a first batch of resin, resin from another ion exchange unit 14 may be regenerated or another source of electron acceptor can be used to maintain the microbial population in the bioreactor 30. The microbial waste stream 38 is estimated to consist of one cubic foot at about 2000 ppm total suspended solids (TSS) every 60 days, or per batch of three cubic feet (85 liters) of resin treated.

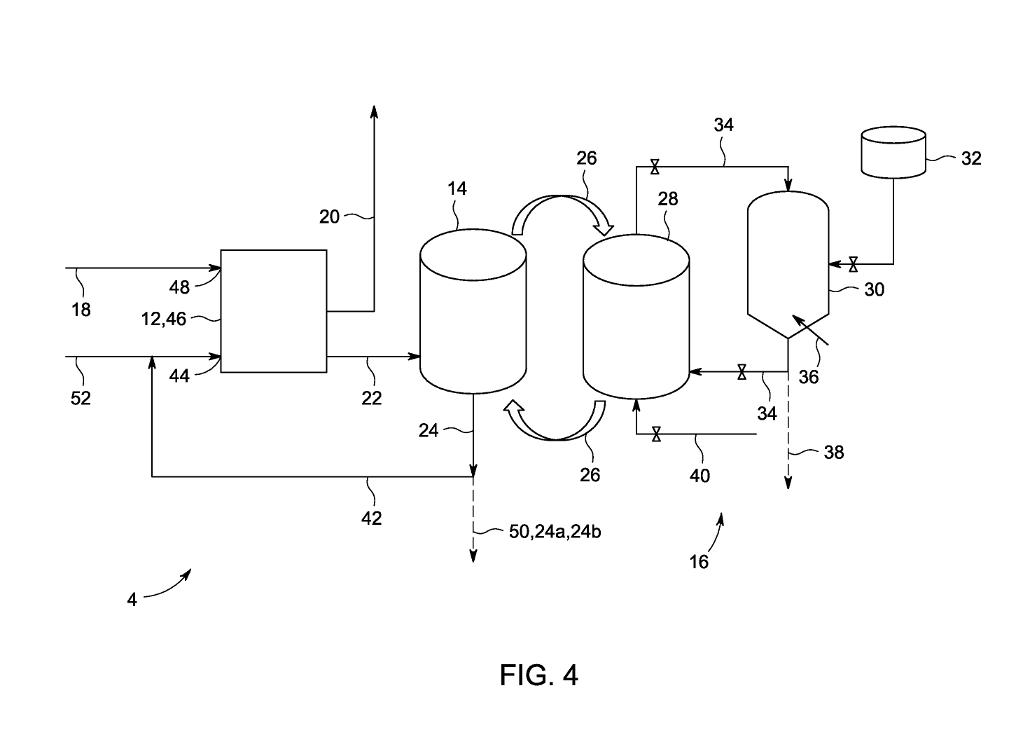

FIG. 4 shows a fourth water treatment system 4 wherein the separation unit 12 is an ED or EDR unit 46 having a product water inlet 48 and a concentrate water inlet 44. In this case, feed water 18 containing perchlorate is fed only to the product water inlet 48. Make up water 52 is fed to the concentrate inlet 44. The make up water 52 has a concentration of perchlorate lower than the concentration of perchlorate in the concentrate stream 22, preferably also lower than the concentration of perchlorate in the feed water 18. For example, the make up water 52 may be municipal water, product water 20 or, preferably, a waste water such as an effluent from a waste water treatment plant. In other respects, the fourth water treatment system 4 operates as described in relation to FIG. 2. However, because the make up water 52 has a low concentration of perchlorate, a larger amount of the second product water 24 can be diverted to the concentrate recycle stream 42 relative to FIG. 2. The flow rate of make up water 52 is correspondingly less than the flow rate of feed water 18 to the concentrate inlet 44 in FIG. 2. A blowdown stream 50 removes contaminants that would otherwise accumulate in the concentrate recirculation loop 22, 42. While the blowdown stream 50 may be used as described for product water streams 24a or 24b, blowdown stream 50 is small relative to the corresponding product water streams 24a or 24b in FIG. 2 and is more likely to be discharged. In this way, subject to losses such as electro-osmosis and leaks, essentially all of the feed water 18 can be recovered as first product water 20 without being mixed with second product water 24b. This avoids contact of the first product water 20 with the resin in the IX unit 14 which is periodically contacted with microbes. The first product water 20 may therefore be usable without being sterilized, or may be easier to sterilize, or may simply provide comfort that live microbes from the regeneration system 16 are not present in the product water 20.

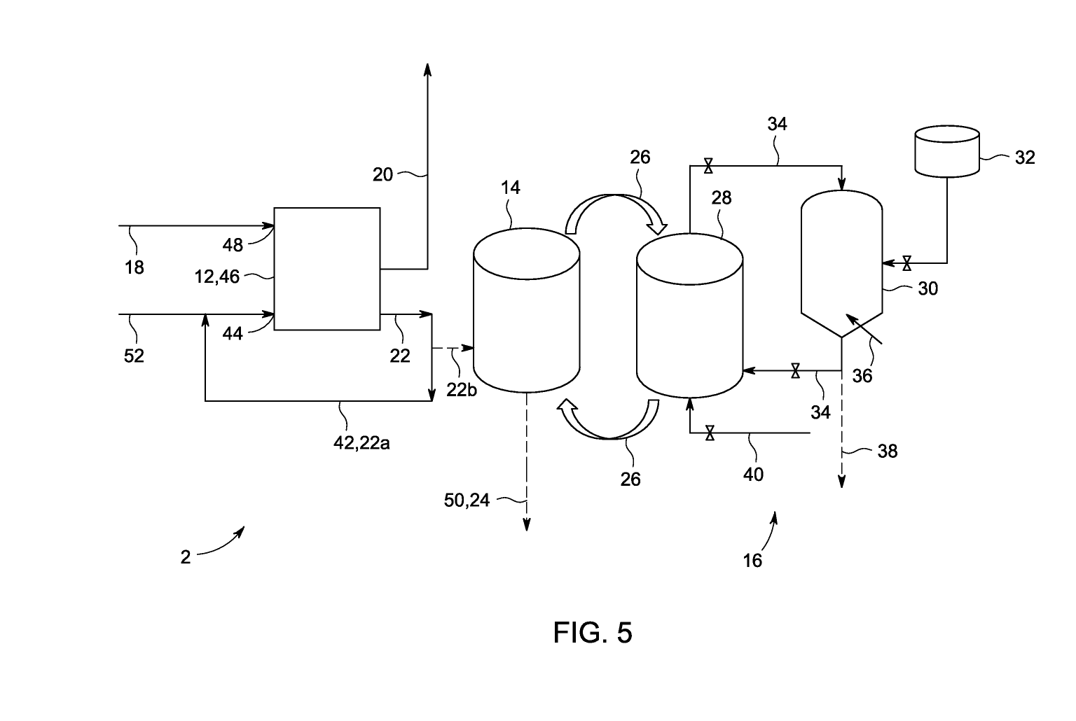

FIG. 5 shows a fifth water treatment system 2 similar to FIG. 3 but using make up water 52 and producing a small blowdown stream 50 in a manner similar to the description of FIG. 4. The second portion 22b of the concentrate stream 22 in FIG. 5 is smaller than the corresponding stream in FIG. 3. As described in relation to FIG. 4, essentially all of the feed water 18 is converted into first product water 20 without being mixed with water that has contacted the resin in the IX unit 14.

Optionally, an RO or NF membrane system based separation unit 12 can be made to operate with increased recovery of first product water 20. Referring to FIG. 1, a first portion of concentrate 22 may be recycled to join feed water 18 while a second portion of concentrate 22 is sent to the IX unit 14. Alternatively, a portion of second product water 24 may be recycled to join feed water 18.

Without limiting any claimed invention to any particular use or advantage, or to the solution of any particular problem, and without promising to provide any particular result other than the removal of at least some of an oxidant from a feed water, the inventors believe that the process and apparatus described above have various attributes or characteristics that may be desirable in at least some circumstances. For example, providing a first stage concentration step allows the size of the IX resin bed and regeneration system to be reduced relative to a process in which the feed water flows directly into an IX resin bed. If the IX unit 14 is regenerated biologically, the perchlorate may be retained to a sufficiently high level so that it can serve as the sole or primary energy source for the perchlorate-reducing microorganisms. The process and apparatus described herein do not depend on combining the concentrate with a domestic wastewater stream and, particularly when treating non-brackish water, the concentrate can be recovered as product water. In the case of brackish feed water, salinity is removed in the separation unit 12, whereas it would not be removed in an IX unit alone. It is possible that the increase in ionic strength of the concentrate 22 over the feed water 18 may make the IX resin more selective for monovalent ions such as perchlorate.

U.S. Pat. Nos. 7,318,895, 7,407,581 and 7,465,400 are incorporated herein by this reference to them. The process and apparatus may be adapted for treating waters contaminated with other oxidants such as nitrate, phosphate or sulphate.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A process for treating feed water comprising an oxidant, the process comprising the steps of,
a) producing a concentrate containing oxidant separated from the feed water;
b) contacting the concentrate with an ion exchange material to remove oxidant from the concentrate; and,
c) regenerating the ion exchange material.

2. The process of claim 1 wherein the ion exchange material is regenerated by biological digestion.

3. The process of claim 1 wherein the feed water is brackish and the concentrate has an increased salinity relative to the feed water.

4. The process of claim 3 further comprising a step of desalting the concentrate.

5. The process of claim 1 wherein the concentrate is produced in a separation unit selected from the group of an RO unit, a NF unit, an ED unit and an EDR unit.

6. (canceled)

7. The process of claim 1 wherein step c) comprises flowing water containing oxidant digesting microorganisms through the ion exchange material in an ion exchange unit or a fluidized bed reactor.

8. The process of claim 1 wherein the water after step a) and at least a portion of the concentrate after step b) are used for potable water.

9. The process of claim 6 wherein at least a portion of the concentrate after step b) is recycled to a concentrate inlet of the ED or EDR unit.

10. The process of claim 9 further comprising a step of providing make up water to the concentrate inlet wherein the makeup water has a lower concentration of the oxidant than the feed water.

11. The process of claim 1 wherein the oxidant is perchlorate.

12. The process of claim 11 wherein the concentrate is produced in an ED or EDR unit having a nitrate selective or perchlorate selective membrane.

13. The process of claim 11 wherein the ion exchange material is perchlorate selective.

14. The process of claim 11 having a step of removing nitrate or sulphate from the feed water before step a) or step b).

15. An apparatus for treating feed water comprising an oxidant, the apparatus comprising,
a) a separation unit to receive the feed water;
b) an ion exchange unit to receive a concentrate from the separation unit; and,
c) a regeneration system.

16. The apparatus according to claim 15 wherein the separation unit is selected from the group of an RO unit, a NF unit, an ED unit and an EDR unit.

17. (canceled)

18. The apparatus according to claim 17 comprising a recirculation line carrying a portion of the concentrate to a concentrate inlet of the separation unit.

19. The apparatus according to claim 18 wherein the concentrate inlet is in communication with a supply of make up water having a concentration of the oxidant less than the concentration of the oxidant in the concentrate.

20. The apparatus according to claim 19 wherein the concentrate inlet is in communication with a supply of make up water having a concentration of the oxidant less than the concentration of the oxidant in the feed water.

21. The apparatus according to claim 15 wherein the oxidant is perchlorate.

22. The apparatus according to claim 15 wherein the regeneration system comprises a bioreactor.
